(19) United States
(12) Patent Application Publication
(10) Pub. No.: US 2021/0362104 A1
(43) Pub. Date: Nov. 25, 2021

(54) FLUID MIXING DEVICE

(71) Applicant: Kiyan Samei, Tehran (IR)

(72) Inventor: Kiyan Samei, Tehran (IR)

(21) Appl. No.: 17/398,994

(22) Filed: Aug. 10, 2021

Related U.S. Application Data
(63) Continuation-in-part of application No. PCT/IB2019/059643, filed on Nov. 10, 2019.

(51) Int. Cl. B01F 5/04

(52) U.S. Cl. CPC B01F 5/048; B01F 5/0495

(57) ABSTRACT

A device for mixing a first fluid and a second fluid may include a primary conduit that may extend along a longitudinal axis of the primary conduit between a primary inlet port and a primary outlet port. The primary conduit may have a constant primary inner diameter for an entire length of the primary conduit. The primary inlet port may be connected to a pressurized source of the first fluid. The device may further include at least one secondary conduit that may extend parallel with the primary conduit. The secondary conduit may include a secondary inlet port and a secondary outlet port. The secondary conduit may have a constant secondary inner diameter. The secondary inner diameter may be smaller than the primary inner diameter. The primary conduit may encompass at least a portion of the secondary conduit. The secondary outlet portion may be disposed within the primary conduit. The secondary inlet port may be connected in fluid communication with a source of the second fluid.

### CROSS-REFERENCE TO RELATED APPLICATION

This application is a continuation-in-part of International Patent Application PCT/IB2019/059643, filed on Oct. 11, 2019, and entitled “A FLUID MIXING DEVICE,” which is incorporated herein by reference in its entirety.

### TECHNICAL FIELD

The present disclosure relates to a fluid mixing device. More particularly relates to a fluid aeration device that may be utilized for dissolving air into a fluid.

### BACKGROUND

The alarming rate of water depletion on Earth means that we are facing critical water scarcity in most areas of the world. In fact, in certain areas, we are already there. It is known that the amount of freshwater consumption around the world has doubled during the past two decades. Accordingly, it is necessary to find ways to reduce the amount of water consumption to avoid a lack of available freshwater resources.

One way to address the issue of water scarcity is utilizing technical solutions in plumbing equipment that may allow for decreasing the amount of water and energy that is being consumed. To this end, various devices, such as mechanical limiters, aerators, and reducers of water flow may be utilized. Such devices may either be factory-fitted in plumbing equipment or additional devices that may be added to existing plumbing systems. Various water-saving devices have been produced and marketed, such as water-saving nozzles that are developed to reduce the water flow rate as much as possible, while maintaining the spray force of water or even improving the coverage area of water discharged from the nozzle. Examples of such devices may be found in WO2019084633A1 or U.S. Pat. No. 4,123,800. In such devices, ambient air is sucked in and injected into the stream of water, and this way, a lower flow rate of water may produce a higher spray force and a larger coverage area.

However, the aforementioned water-saving devices may be associated with issues, including but not limited to being application-specific, meaning that most of these water-saving devices are designed for a particular use. For example, a water-saving shower or a water-saving faucet with fittings cannot be generally used on other water outlets. Low efficiency and high prices are among other issues that make these devices less appealing to the public.

There is, therefore, a need for a device that may be able to inject a significant amount of air into the stream of water to increase the spray force of water while significantly reducing the amount of water consumption. There is further a need for a device that may be added to existing water outlets such as showers, hoses, faucets, and other water outlets such as those in washing machines and dishwashers.

### SUMMARY

This summary is intended to provide an overview of the subject matter of the present disclosure and is not intended to identify essential elements or key elements of the subject matter, nor is it intended to be used to determine the scope of the claimed implementations. The proper scope of the present disclosure may be ascertained from the claims set forth below in view of the detailed description and the drawings.

According to one or more exemplary embodiments, the present disclosure is directed to a device for mixing a first fluid and a second fluid. An exemplary device may include a primary conduit that may extend along a longitudinal axis of an exemplary primary conduit between a primary inlet port and a primary outlet port. An exemplary primary conduit may have a constant primary inner diameter for an entire length of an exemplary primary conduit. An exemplary primary inlet port may be connected to a pressurized source of an exemplary first fluid. an exemplary device may further include at least one secondary conduit that may extend parallel with an exemplary primary conduit. an exemplary secondary conduit may include a secondary inlet port and a secondary outlet port. An exemplary secondary conduit may have a constant secondary inner diameter. An exemplary secondary inner diameter may be smaller than an exemplary primary inner diameter. An exemplary primary conduit may encompass at least a portion of an exemplary secondary conduit. an exemplary secondary outlet portion may be disposed within an exemplary primary conduit. An exemplary secondary inlet port may be connected in fluid communication with a source of an exemplary second fluid.

According to one or more exemplary embodiments, the present disclosure is directed to a method for mixing a first fluid and a second fluid. An exemplary method may include providing a fluid conduit. An exemplary fluid conduit may include a first portion with a first cross-sectional area of flow. An exemplary first portion may extend between a first inlet and a first outlet along a longitudinal axis of an exemplary first portion. An exemplary fluid conduit may further include a second portion with a second cross-sectional area of flow. An exemplary second portion may extend between a second inlet and a second outlet along a longitudinal axis of an exemplary second portion. An exemplary second cross-sectional area of flow may be larger than an exemplary first cross-sectional area of flow. An exemplary first outlet of an exemplary first portion may be connected to an exemplary second inlet of an exemplary second portion. An exemplary fluid conduit may further include a shoulder that may be formed between an exemplary first outlet of an exemplary first portion and an exemplary second inlet of an exemplary second portion. An exemplary plane of an exemplary shoulder may be perpendicular to an exemplary longitudinal axis of an exemplary second portion.

An exemplary method may further include introducing a pressurized stream of an exemplary first fluid into an exemplary fluid conduit, where an exemplary pressurized stream of first fluid may flow from an exemplary first inlet port of an exemplary first portion to an exemplary second outlet of the second portion, and connecting a source of an exemplary second fluid in fluid communication to an exemplary second inlet of an exemplary second portion.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates a sectional side view of a fluid conduit with a sudden axisymmetric increase in cross-sectional area of the fluid conduit, consistent with one or more exemplary embodiments of the present disclosure;

FIG. 2 illustrates a sectional side view of a fluid conduit with a sudden increase in cross-sectional area of the fluid conduit, consistent with one or more exemplary embodiments of the present disclosure;

FIG. 3A illustrates a sectional side view of a device for mixing a secondary fluid into a primary fluid, consistent with one or more exemplary embodiments of the present disclosure;

FIG. 3B illustrates a perspective view of a device for mixing a secondary fluid into a primary fluid, consistent with one or more exemplary embodiments of the present disclosure;

FIG. 4A illustrates a sectional side view of a device for mixing a secondary fluid into a primary fluid with parallel injection, consistent with one or more exemplary embodiments of the present disclosure;

FIG. 4B illustrates a perspective view of a device for mixing a secondary fluid into a primary fluid with parallel injection, consistent with one or more exemplary embodiments of the present disclosure;

FIG. 5 illustrates a sectional side view of a device for mixing a secondary fluid into a primary fluid, consistent with one or more exemplary embodiments of the present disclosure;

FIG. 6 illustrates a sectional side view of a device for mixing a first fluid into a second fluid, consistent with one or more exemplary embodiments of the present disclosure;

FIG. 7 illustrates a sectional side view of a device for mixing a first fluid into a second fluid, consistent with one or more exemplary embodiments of the present disclosure;

FIG. 8 illustrates a sectional side view of a device for mixing a first fluid into a second fluid, consistent with one or more exemplary embodiments of the present disclosure; and

FIG. 9 illustrates a flow chart of a method for mixing a first fluid with a second fluid, consistent with one or more exemplary embodiments of the present disclosure.

### DETAILED DESCRIPTION

In the following detailed description, numerous specific details are set forth by way of examples to provide a thorough understanding of the relevant teachings related to the exemplary embodiments. However, it should be apparent that the present teachings may be practiced without such details. In other instances, well-known methods, procedures, components, and circuitry have been described at a relatively high-level, without detail, to avoid unnecessarily obscuring aspects of the present teachings.

The following detailed description is presented to enable a person skilled in the art to make and use the methods and devices disclosed in exemplary embodiments of the present disclosure. For purposes of explanation, specific nomenclature is set forth to provide a thorough understanding of the present disclosure. However, it will be apparent to one skilled in the art that these specific details are not required to practice the disclosed exemplary embodiments. Descriptions of specific exemplary embodiments are provided only as representative examples. Various modifications to the exemplary implementations will be plain to one skilled in the art, and the general principles defined herein may be applied to other implementations and applications without departing from the scope of the present disclosure. The present disclosure is not intended to be limited to the implementations shown but is to be accorded the broadest possible scope consistent with the principles and features disclosed herein.

According to one or more exemplary embodiments, the present disclosure is directed to a device for mixing a secondary fluid such as air into a primary fluid such as water for purposes that may include but are not limited to reducing water consumption in domestic or industrial water outlets. An exemplary device may include a fluid conduit that may have two portions with different cross-sectional areas of flow. An exemplary first portion that may be connected to a pressurized primary fluid source, such as a water faucet and an exemplary second portion that may be connected in fluid communication with an exemplary first portion.

An exemplary first portion may have a first cross-sectional area, and an exemplary second portion may have a second cross-sectional area. An exemplary first cross-sectional area may be smaller than an exemplary second cross-sectional area. Since a cross-sectional area of an exemplary first portion is smaller than a cross-sectional area of an exemplary second portion, a shoulder may be formed between an exemplary first portion and an exemplary second portion. For example, for an exemplary cylindrical first portion that may be connected to a cylindrical second portion, connecting an exemplary first portion and an exemplary second portion may form an annular shoulder between an exemplary first portion and an exemplary second portion.

An exemplary first portion may have a first cross-sectional area that may extend an entire length of an exemplary first portion and an exemplary second portion may have a second cross-sectional area that may extend an entire length of an exemplary second section. For example, for an annular first portion with a first diameter connected to or integrally formed with an annular second portion, the first diameter may extend an entire length of an exemplary annular first portion and the second diameter may extend an entire length of an exemplary annular second portion.

As a pressurized primary fluid flows through an exemplary fluid conduit of sudden increasing cross-sectional area as described above, a significant amount of energy may be irreversibly transferred from an exemplary primary fluid flow to recirculating eddies that may form within an exemplary second portion of an exemplary fluid conduit downstream of an exemplary shoulder. An exemplary flow of a primary fluid in such an exemplary fluid conduit of a sudden increasing cross-sectional area may be subjected to an adverse pressure gradient, which may result in flow separation from exemplary walls of an exemplary fluid conduit as the cross-sectional area of flow suddenly increases. After flowing a certain distance within an exemplary second portion of an exemplary fluid conduit from an exemplary shoulder, the flow of an exemplary primary fluid may reattach exemplary walls of an exemplary fluid conduit. This certain distance may be referred to herein as a reattachment length.

An exemplary fluid conduit may further include inlet ports that may open into an exemplary second portion of an exemplary fluid conduit within a discharge zone downstream of an exemplary shoulder of an exemplary fluid conduit. An exemplary discharge zone may be a zone immediately downstream of an exemplary shoulder where flow detachment from an exemplary wall occurs. An exemplary discharge zone may have a length equal to an exemplary reattachment length within an exemplary second portion of an exemplary fluid conduit. In an exemplary discharge zone, a recirculation zone may be formed due to flow detachment. An exemplary recirculation area may have relatively low pressure. This exemplary low-pressure discharge zone may create suction within inlet ports that may open into an exemplary discharge zone. This suction may be utilized for introducing an exemplary secondary fluid, such as air, into a stream of an exemplary primary fluid. An exemplary secondary fluid may be sucked into an exemplary fluid conduit and may be mixed with an exemplary primary fluid downstream of an exemplary discharge zone.

As used herein, a second object being downstream from a first object may refer to a configuration where a fluid flowing within an exemplary fluid conduit may reach the first object first and then the second object. Similarly, as used herein, a second object being upstream from a first object may refer to a configuration where a fluid flowing within an exemplary fluid conduit may reach the second object first and then flows towards the first object. For example, an exemplary discharge zone being downstream from an exemplary shoulder may refer to a configuration where a fluid flowing through an exemplary fluid conduit may first pass an exemplary shoulder and then may reach an exemplary discharge zone.

For example, an exemplary primary fluid may be water, and an exemplary secondary fluid may be air. An exemplary device may be connected to a water faucet, and as water from an exemplary water faucet flows into an exemplary device, air may be sucked into an exemplary water stream. In exemplary embodiments, such introduction of air into a water stream may allow for providing higher spray forces for lower water flow rates, which may considerably save water. Accordingly, an exemplary device for mixing a primary fluid with a secondary fluid may find various applications and may be used as a water-saving device in domestic and industrial settings, an aeration device that may find application in, for example, water treatment plants.

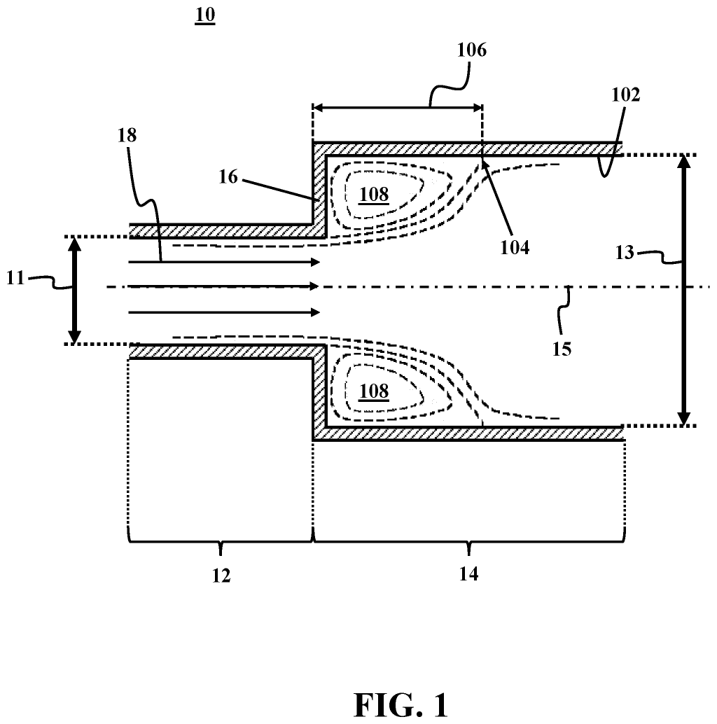

FIG. 1 illustrates a sectional side view of an exemplary fluid conduit 10 with a sudden axisymmetric increase in cross-sectional area of flow, consistent with one or more exemplary embodiments of the present disclosure. In an exemplary embodiment, fluid conduit 10 may include a first portion 12 that may be connected to or integrally formed with a second portion 14. In an exemplary embodiment, first portion 12 may have a first cross-sectional area of flow, and second portion 14 may have a second cross-sectional area of flow. In an exemplary embodiment, the first cross-sectional area of flow may be smaller than the second cross-sectional area of flow.

In an exemplary embodiment, first portion 12 and second portion 14 may include cylindrical portions that may be connected to or integrally formed with each other. In an exemplary embodiment, first portion 12 may have a first diameter 11 that may extend an entire length of first portion 12 and second portion 14 may have a second diameter 13 that may extend an entire length of second portion 14. In an exemplary embodiment, first diameter 11 may be smaller than second diameter 13, consequently, a fluid passing through fluid conduit 10 may experience a sudden change in the cross-sectional area of flow where first portion 12 and second portion 14 are connected to each other.

In an exemplary embodiment, first portion 12 and second portion 14 may have square or rectangular cross-sections. In an exemplary embodiment, first portion 12 may have a first height and a first width that may be constant for an entire length of first portion 12 and second portion 14 may have a second height and a second width that may be constant for an entire length of second portion 14. In an exemplary embodiment, the first height may be smaller than the second height and the first width may be smaller than the second width, consequently, a fluid passing through fluid conduit 10 may experience a sudden change in the cross-sectional area of flow where first portion 12 and second portion 14 are connected to each other.

In an exemplary embodiment, a sudden increase in the cross-sectional area of fluid conduit 10 may form a shoulder 16 between first portion 12 and second portion 14. In an exemplary axisymmetric sudden increase in cross-sectional area, first portion 12 may be coaxially aligned with second portion 14. As used herein, first portion 12 and second portion 14 being coaxially aligned may refer to a configuration where a longitudinal central axis of first portion 12 is aligned with a longitudinal central axis of second portion 14 on a common central longitudinal axis 15. For example, when first portion 12 and second portion 14 are cylindrical portions, an annular shoulder, such as shoulder 16 that may be coaxially aligned with first portion 12 and second portion 14 may be formed between first portion 12 and second portion 14.

In an exemplary embodiment, fluid conduit 10 may be configured to allow for a pressurized fluid stream 18 to flow through fluid conduit 10. For example, fluid conduit 10 may be connected to a pressurized fluid source, such as a water faucet. In an exemplary embodiment, as pressurized fluid stream 18 flows through fluid conduit 10, due to sudden expansion within fluid conduit 10, pressurized fluid stream 18 may be subjected to an adverse pressure gradient, which may result in flow separation from a wall 102 of fluid conduit 10 as the cross-sectional area suddenly increases. A low-pressure recirculation zone 108 may be formed as a result of sudden expansion, immediately downstream of shoulder 16. In other words, toroidal vortexes and turbulence may be created in low-pressure recirculation zone 108, and the pressure of pressurized fluid stream 18 significantly decreases in low-pressure recirculation zone 108. For example, in an axisymmetric sudden expansion configuration, as shown in FIG. 1, low-pressure zone 108 may be formed axisymmetrically downstream of shoulder 16. As used herein, low-pressure zone 108 being axisymmetrically formed may refer to low-pressure zone 108 being formed exhibiting symmetry around central longitudinal axis 15. In an exemplary embodiment, as pressurized fluid stream 18 flows through fluid conduit 10, pressurized fluid stream 18 may reattach to wall 102 of fluid conduit 10, and a distance from shoulder 16 to a point 104, at which pressurized fluid stream 18 reattaches wall 102 may be referred to herein as a reattachment length 106. In exemplary embodiments, low-pressure zone 108 may be utilized to provide suction for introducing a secondary fluid into the stream of pressurized fluid stream 18, as will be discussed.

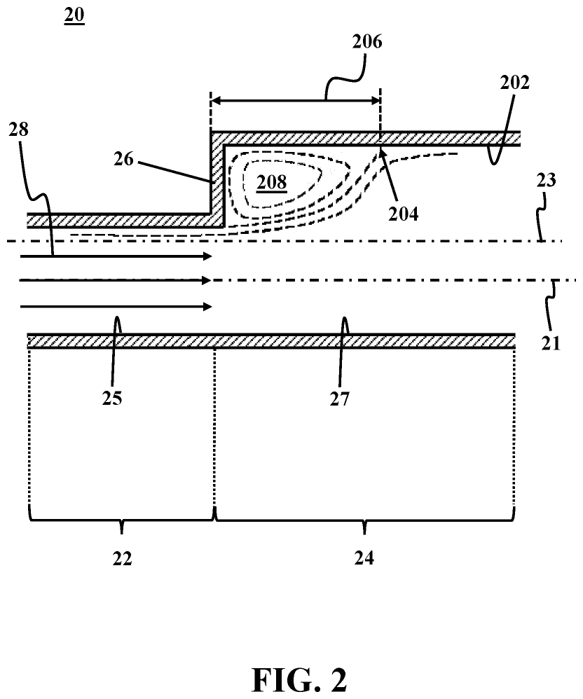

FIG. 2 illustrates a sectional side view of an exemplary fluid conduit 20 with a sudden increase in cross-sectional area, consistent with one or more exemplary embodiments of the present disclosure. In an exemplary embodiment, fluid conduit 20 may be similar to fluid conduit 10 and may include a first portion 22 similar to first portion 12 and a second portion 24 similar to second portion 14. In an exemplary embodiment, first portion 22 may be connected to or integrally formed with second portion 24 such that a longitudinal axis 21 of first portion 22 may not be aligned with a longitudinal axis 23 of second portion 24. In an exemplary embodiment, first portion 22 may have a first cross-sectional area of flow, and second portion 24 may have a second cross-sectional area of flow. In an exemplary embodiment, the first cross-sectional area of flow may be smaller than the second cross-sectional area of flow. In an exemplary embodiment, such difference in the first and second cross-sectional areas may form a shoulder 26 between first portion 22 and second portion 24. In an exemplary embodiment, shoulder 26 may be formed on one side of fluid conduit 20 and in the other opposing side of fluid conduit 20, an inner wall 25 of first portion 22 may lie flush with an inner wall 27 of second portion 24. In an exemplary embodiment, fluid conduit 20 may be configured to allow for a pressurized fluid stream 28 to flow through fluid conduit 20. For example, fluid conduit 20 may be connected to a pressurized fluid source, such as a water faucet. In an exemplary embodiment, as pressurized fluid stream 28 flows through fluid conduit 20, the pressurized fluid may undergo a sudden expansion due to the sudden reduction in the cross-sectional area of flow within fluid conduit 20. Consequently, pressurized fluid flow 28 may be subjected to an adverse pressure gradient, which may result in flow separation from an inner wall 202 of fluid conduit 20 as the cross-sectional area suddenly increases. In an exemplary embodiment, as pressurized fluid stream 28 flows through fluid conduit 20, pressurized fluid stream 28 may reattach to wall 202 of fluid conduit 20, and a distance from shoulder 26 to a point 204, at which pressurized fluid stream 28 flow reattaches inner wall 202 may be referred to herein as a reattachment length 206. A low-pressure recirculation zone may be formed as a result of sudden expansion, immediately downstream of shoulder 26. In exemplary embodiments, such low-pressure zone 208 may be utilized to provide suction for introducing a secondary fluid into the stream of pressurized fluid stream 28, as will be discussed.

In an exemplary embodiment, an exemplary fluid conduit, such as fluid conduit 10 and fluid conduit 20 may include two exemplary portions, one with a smaller cross-sectional area, such as first portion 12 or first portion 22, and one with a larger cross-sectional area, such as second portion 14 and second portion 24. In an exemplary embodiment, an exemplary portion with a smaller cross-sectional area may be attached to or integrally formed with an exemplary portion with a larger cross-sectional area, either coaxially, such as fluid conduit 10 or not coaxially, such as fluid conduit 20. As mentioned before, such configurations of fluid conduit 10 and fluid conduit 20 may allow for creating a low-pressure zone within fluid conduits (10 and 20) that may later be utilized for drawing in a secondary fluid into conduits (10 and 20) to be mixed with pressurized fluid streams (18 and 28).

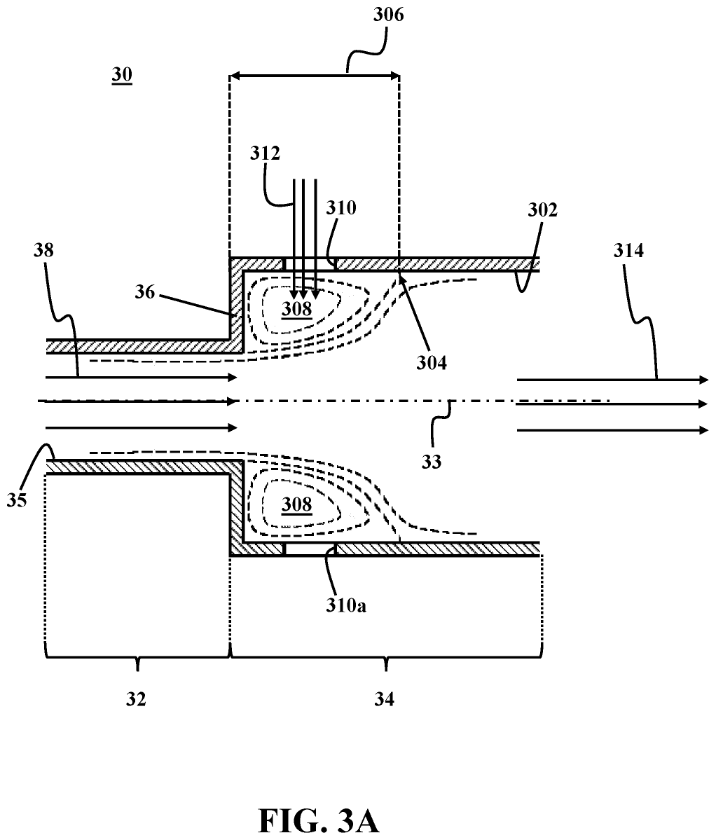

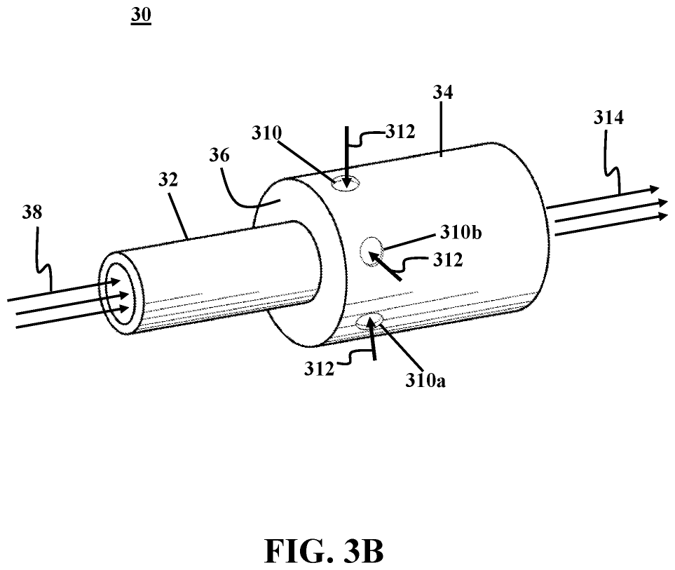

FIG. 3A illustrates a sectional side view of a device 30 for mixing a secondary fluid into a primary fluid, consistent with one or more exemplary embodiments of the present disclosure. FIG. 3B illustrates a perspective view of device 30 for mixing a secondary fluid into a primary fluid, consistent with one or more exemplary embodiments of the present disclosure. In an exemplary embodiment, device 30 may include a fluid conduit that may be similar to fluid conduit 10 and may include a first portion 32 similar to first portion 12 and a second portion 34 similar to second portion 14. In an exemplary embodiment, first portion 32 may have a first cross-sectional area of flow, and second portion 34 may have a second cross-sectional area of flow. In an exemplary embodiment, the first cross-sectional area of flow may be smaller than the second cross-sectional area of flow. In an exemplary embodiment, a sudden increase in cross-sectional area of device 30 may form a shoulder 36 similar to shoulder 16 between first portion 32 and second portion 34. In an exemplary axisymmetric sudden expansion in cross-sectional area, first portion 32 may be concentric with second portion 34. In an exemplary embodiment, the first cross-sectional area of first portion 32 may extend an entire length of first portion 32 and the second cross-sectional area of second portion 34 may extend an entire length of second portion 34.

In an exemplary embodiment, device 30 may be configured to allow for a pressurized primary fluid stream 38 to flow through device 30. For example, device 30 may be connected to a pressurized fluid source, such as a water faucet. In an exemplary embodiment, first portion 32 may include an inlet port 35 that may be coupled with a pressurized source of an exemplary primary fluid. In an exemplary embodiment, inlet port 35 may be configured to allow for a pressurized fluid stream, such as pressurized primary fluid stream 38 to coaxially enter device 30.

In an exemplary embodiment, a plane of shoulder 36 may be perpendicular to a centerline of device 30 and a ratio of the cross-sectional area of flow within first portion 32 to the cross-sectional area of flow within second portion 34 may be between 0.01 and 1. As used herein, the centerline 33 of device 30 may be superimposed on a longitudinal axis of first portion 32 and a longitudinal axis of second portion 34. In an exemplary embodiment, pressurized primary fluid stream 38 being coaxially introduced into device 30 may refer to pressurized primary fluid stream 38 being introduced along centerline 33.

In an exemplary embodiment, as pressurized primary fluid stream 38 flows through device 30, due to sudden expansion within device 30, pressurized primary fluid stream 38 may be subjected to a sudden pressure decrease, which may result in flow separation from a wall 302 of device 30 as the cross-sectional area suddenly increases. A low-pressure recirculation zone 308 may be formed as a result of sudden expansion, immediately downstream of shoulder 36. For example, in an axisymmetric sudden expansion configuration, as shown in FIGS. 3A and 3B, low-pressure zone 308 may be formed immediately downstream of shoulder 36. In an exemplary embodiment, as primary fluid stream 38 flows through device 30, primary fluid stream 38 may reattach to wall 302 of device 30, and a distance from shoulder 36 to a point 304, at which primary fluid stream 38 flow reattaches wall 302 may be referred to herein as a reattachment length 306. In exemplary embodiments, low-pressure zone 308 may form symmetrically around centerline 33 of device 30.

In an exemplary embodiment, device 30 may further include at least one inlet port 310 that may penetrate through wall 302 and may open into low-pressure zone 308. In an exemplary embodiment, inlet port 310 may open into low-pressure zone 308 anywhere on wall 302 along reattachment length 306. In an exemplary embodiment, inlet port 310 may be configured as an aperture on wall 302 that may be positioned anywhere along reattachment length 306. In an exemplary embodiment, inlet port 310 may be exposed to an atmospheric environment containing an exemplary secondary fluid. For example, device 30 may be configured to be a water aeration device and inlet port 35 of first portion 32 may be coupled to a water faucet and inlet port 310 may be in fluid commu8nication with ambient air at atmospheric pressure.

The suction created in low-pressure zone 308 due to the flow of pressurized primary fluid stream 38 may allow for introducing a secondary fluid stream 312 into the stream of primary fluid stream 38 through inlet port 310. For example, low-pressure zone 308 may be connected in fluid communication to ambient air via inlet port 310 and ambient air as secondary fluid stream 312 may be drawn into primary fluid stream 38 through inlet port 310. In exemplary embodiments, the significant pressure difference between low-pressure zone 308 and ambient air may allow for introducing a considerable amount of air into the stream of water.

In an exemplary embodiment, for axisymmetrically formed low-pressure zone 308 that exhibits symmetry around centerline 33 of device 30, a plurality of inlet ports, such as inlet port 310, inlet port 310a, and inlet port 310b may open into device 30 around a periphery of second portion 34 near shoulder 36, such that the plurality of inlet ports may all open into axisymmetrically formed low-pressure zone 308. The opposite half of device 30, not seen in FIG. 3B includes a similar number of inlet ports. In an exemplary embodiment, the plurality of inlet ports may be any desired number around the periphery of second portion 34. In an exemplary embodiment, each inlet port of the plurality of inlet ports may be radially extended between an outer surface of second portion 34 and an inner surface of second portion 34. In an exemplary embodiment, an outer surface of second portion 34 may be exposed to an atmospheric source of an exemplary secondary fluid. In other words, each inlet port of the plurality of inlet ports, for example, inlet port 310a may be exposed to an atmospheric source of an exemplary secondary fluid from one side and may be exposed to low-pressure zone 308 form another side. Such configuration of each inlet port of the plurality of inlet ports may allow for drawing in exemplary streams of secondary fluid, such as secondary fluid streams 312.

In an exemplary embodiment, at least one inlet port, such as inlet port 310 may be provided for supplying one or more fluids for mixing with primary fluid or for aeration of primary fluid. The plurality of inlet ports, such as inlet port 310, inlet port 310a, and inlet port 310b may deliver secondary fluid stream 312 downstream from shoulder 36 of device 30 into primary fluid stream 38. In exemplary embodiments, after primary fluid stream 38 and secondary fluid stream 312 are mixed within second portion 34 of device 30, a mixture of primary fluid stream 38 and secondary fluid stream 312 may be discharged as a mixed fluid stream 314. For example, mixed fluid stream 314 may be an aerated water stream that may provide high spray forces at relatively lower flow rates, which may contribute to saving water. In exemplary embodiments, device 30 may operate with various fluids as primary fluid stream 38, and also as secondary fluid stream 312, to provide mixing of fluids flowing through device 30.

In an exemplary embodiment, inlet ports, such as inlet port 310, inlet port 310a, and inlet port 310b may be connected to a secondary fluid source (not illustrated) by, for example, a plurality of conduits. In an exemplary embodiment, inlet ports, such as inlet port 310, inlet port 310a, and inlet port 310b may permit independent control of fluid flow by providing valves or other flow regulators and control members. To this end, a plurality of conduits equipped with such flow control instruments may provide fluid communication between inlet port 310, inlet port 310a, and inlet port 310b and a secondary fluid source.

In an exemplary embodiment, device 30 may alternately include a fluid conduit similar to fluid conduit 20, which may provide similar effect as fluid conduit 10. For simplicity, only one embodiment of device 30 utilizing a fluid conduit similar to fluid conduit 10 is illustrated.

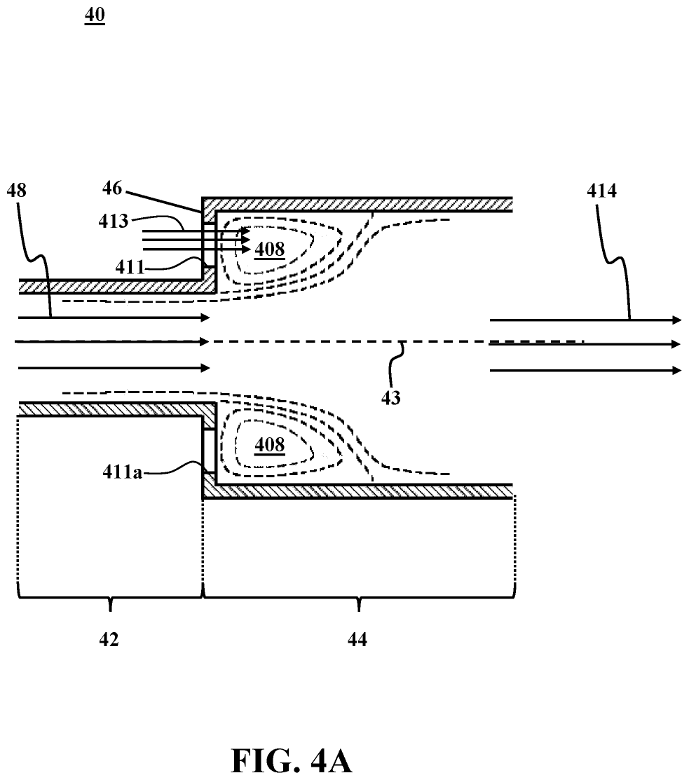

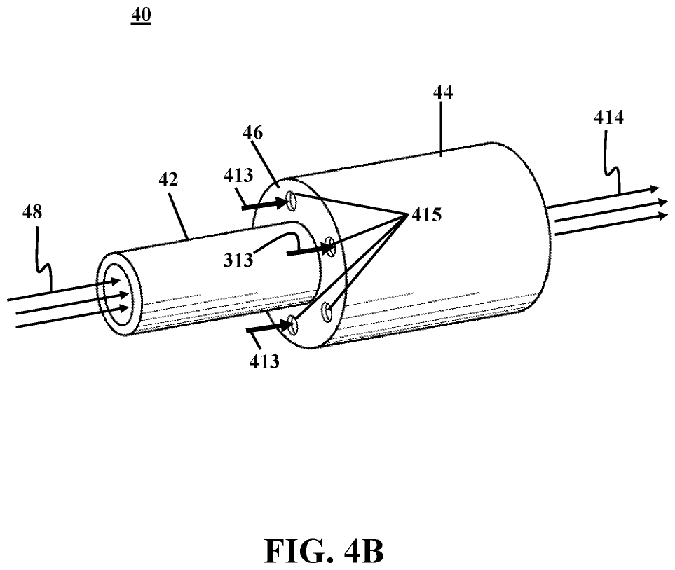

FIG. 4A illustrates a sectional side view of a device 40 for mixing a secondary fluid into a primary fluid with parallel injection, consistent with one or more exemplary embodiments of the present disclosure. FIG. 4B illustrates a perspective view of device 40 for mixing a secondary fluid into a primary fluid with parallel injection, consistent with one or more exemplary embodiments of the present disclosure. In an exemplary embodiment, device 40 may be functionally similar to device 30. In an exemplary embodiment, device 40 may allow for an axial introduction of a secondary fluid into a low-pressure zone 408 formed within device 40, whereas, device 30 may allow for a radial introduction of an exemplary second fluid into low-pressure zone 308.

In an exemplary embodiment, device 40 may include at least one inlet port 411 that may penetrate through a shoulder 46 similar to shoulder 36 and open into low-pressure zone 408, which is similar to low-pressure zone 308. In an exemplary embodiment, inlet port 411 may open into low-pressure zone 408 anywhere on shoulder 46. In an exemplary embodiment, inlet port 411 may be configured as an aperture extending through shoulder 46 parallel with a centerline 43 of device 40.

The suction created in low-pressure zone 408 due to the flow of a pressurized primary fluid stream 48 may allow for introducing a secondary fluid 413 into the stream of primary fluid stream 48 through inlet port 411. For example, low-pressure zone 408 may be connected in fluid communication to ambient air via inlet port 411 and ambient air as secondary fluid 413 may be drawn into the stream of primary fluid 48 through inlet port 411. In this example, primary fluid stream 48 may be water. In an exemplary embodiment, the significant pressure difference between low-pressure zone 408 and ambient air may allow for introducing a considerable amount of air into the stream of water.

In an exemplary embodiment, device 40 may further include a plurality of inlet ports 415, such as inlet port 411 and inlet port 411a, that may open into device 40 around a periphery of shoulder 46, such that plurality of inlet ports 415 may all open into low-pressure zone 408. It should be understood that the opposite half of device 40, not visible in FIG. 4B includes other inlet ports. In an exemplary embodiment, each inlet port of plurality of inlet ports 415 may be extended perpendicular to plane of shoulder 46 and parallel with a centerline 43 of device 40.

In an exemplary embodiment, at least one inlet port, such as inlet port 411 may be provided for supplying one or more fluids for mixing with primary fluid or for aeration of primary fluid. Plurality of inlet ports 415 may deliver secondary fluid 413 downstream from shoulder 46 of device 40 into primary fluid stream 48. In exemplary embodiments, after primary fluid 48 and secondary fluid 413 are mixed within second portion 44 of device 40, a mixture of primary fluid stream 48 and secondary fluid 413 may be discharged as a mixed fluid stream 414. In an exemplary embodiment, mixed fluid stream 414 may be an aerated water stream that may provide high spray forces at relatively lower flow rates, which may contribute to saving water. In exemplary embodiments, device 40 may operate with various fluids as primary fluid stream 48, and also as secondary fluid 413, to provide mixing or aeration of fluids flowing through device 40.

In an exemplary embodiment, inlet ports, such as inlet port 411 may be connected to a secondary fluid source (not illustrated) by, for example, a plurality of conduits. In an exemplary embodiment, inlet ports, such as inlet port 411 may permit independent control of fluid flow by providing valves or other flow regulators and control members. To this end, a plurality of conduits equipped with such flow control instruments may provide fluid communication between inlet port 411 and a secondary fluid source.

In an exemplary embodiment, an exemplary second fluid may be introduced into an exemplary low-pressure zone within an exemplary device for mixing fluids through an exemplary inlet port that may have an angle in a range of 0° to 90° with respect to an exemplary longitudinal axis of an exemplary device. For example, secondary fluid stream 312 may be drawn into low-pressure zone 308 through inlet port 310 at a 90° angle with respect to longitudinal axis 31 of device 30. For example, secondary fluid 412 may be drawn into low-pressure zone 408 through inlet port 410 at a 0° angle with respect to longitudinal axis 41 of device 40. In an exemplary embodiment, an exemplary secondary fluid may be introduced into an exemplary stream of an exemplary primary fluid at a direction that may make an angle between 0° and 180° with an exemplary flow direction of an exemplary primary flow. In other words, an exemplary secondary fluid may be discharged into an exemplary primary fluid along a second flow direction while an exemplary primary fluid is flowing within an exemplary device along a first flow direction. In exemplary embodiments, an angle between an exemplary first flow direction and an exemplary second flow direction may be between 0° and 180°.

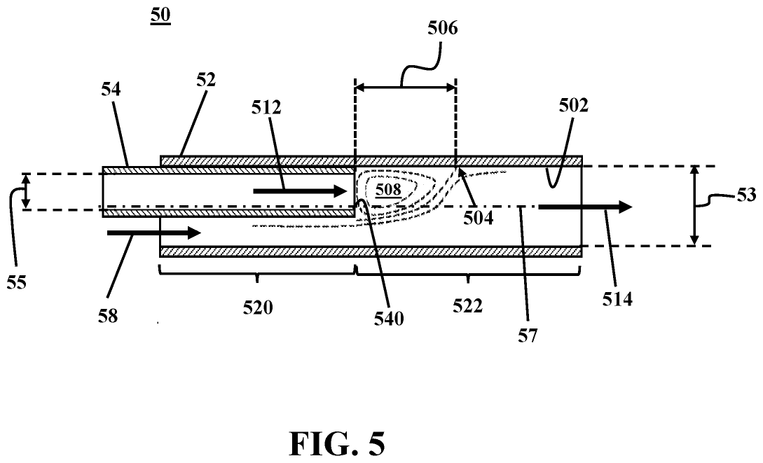

FIG. 5 illustrates a sectional side view of a device 50 for mixing a secondary fluid stream 512 into a primary fluid stream 58, consistent with one or more exemplary embodiments of the present disclosure. In an exemplary embodiment, device 50 may include a first fluid conduit 52 that may be configured to allow for primary fluid stream 58 to flow through first fluid conduit 52 along a first flow direction. In an exemplary embodiment, first fluid conduit 52 may be a straight conduit extended along a centerline 57 of device 50. In an exemplary embodiment, first fluid conduit 52 may have a first cross-sectional area extended an entire length of first fluid conduit 52. For example, first fluid conduit 52 may include an annular conduit with a first inner diameter 53 that may be constant for an entire length of first fluid conduit 52.

In an exemplary embodiment, device 50 may further include second fluid conduit 54 that may be disposed within first fluid conduit 52. In an exemplary embodiment, second fluid conduit 54 may be configured to allow for discharging secondary fluid stream 512 into first fluid conduit 52 along a second flow direction. In an exemplary embodiment, second fluid conduit 54 may have a second cross-sectional area extended an entire length of second fluid conduit 54. For example, second fluid conduit 54 may include an annular conduit with a second inner diameter 55 that may extend an entire length of second fluid conduit 54.

In an exemplary embodiment, second fluid conduit 54 may be parallel with first fluid conduit 52 and the first cross-sectional area of first fluid conduit 52 may be larger than the second cross-sectional area of second fluid conduit 54. For example, first inner diameter 53 may be larger than second inner diameter 55. In an exemplary embodiment, a ratio of second inner diameter 55 to first inner diameter 53 may be between 0.1 and 1. In an exemplary embodiment, second fluid conduit 54 may be disposed within first fluid conduit 52, such that second fluid conduit 54 may at least partially extend along first fluid conduit 52 and an outlet 540 of second fluid conduit 54 may be positioned within first fluid conduit 52. This way, fluid flow within second fluid conduit 54 may be discharged within first fluid conduit 52. In an exemplary embodiment, second fluid conduit 54 may be divided into a first portion 520 that encompasses at least a portion of second fluid conduit 54 and a second portion 522. In an exemplary embodiment, second fluid conduit 54 may occupy a portion of cross-sectional area of flow within first portion 520, consequently, the cross-sectional area of flow within first portion 520 is smaller than the cross-sectional area of flow within second portion 522.

As was discussed in earlier sections, when pressurized primary fluid 58 flows through first fluid conduit 52, due to presence of second fluid conduit 54 within first fluid conduit 52, primary fluid may flow through first portion 520 with a small cross-sectional area of flow, and then pressurized primary fluid 58 may enter second portion 522 with a larger cross-sectional area of flow. Such sudden increase in the cross-sectional area of flow may lead to creating a sudden change of pressure within primary fluid flow 58, which may result in flow separation from a wall of device 50 as the cross-sectional area suddenly increases. This flow separation may lead to the generation of a low-pressure zone 508 immediately after outlet 540 of second fluid conduit 54. In exemplary embodiments, such creation of low-pressure zone 508 may create suction within second fluid conduit 54. In an exemplary embodiment, secondary fluid 512 may be drawn into first fluid conduit 52 through second fluid conduit 54. For example, second fluid conduit 54 may be in fluid communication with ambient air, and when a primary fluid such as water flows through first fluid conduit 52, due to generation of low-pressure zone 508 within first fluid conduit 52, ambient air may be drawn into second fluid conduit 54 and may be introduced into the stream of water. In exemplary embodiments, this introduction of air into water under the suction generated as a result of water flowing within device 50 may allow for introduction of a significant amount of air into water. In exemplary embodiment, second fluid conduit 54 may be placed anywhere within first fluid conduit 52 provided that outlet 540 of second fluid conduit 54 may be positioned within first fluid conduit 52.

Referring to FIG. 5, in an exemplary embodiment, a longitudinal axis of second fluid conduit 54 may be parallel but not aligned with a longitudinal axis of first fluid conduit 52. In an exemplary embodiment, at least a portion of an outer surface of second fluid conduit 54 may contact at least a portion of an inner surface of first fluid conduit 52.

In an exemplary embodiment, second fluid conduit 54 may have a misaligned but parallel longitudinal axis with first fluid conduit 52 as illustrated in FIG. 5. In an exemplary embodiment, second fluid conduit 54 may be parallel and coaxial with first fluid conduit 52, which, for simplicity, is not illustrated.

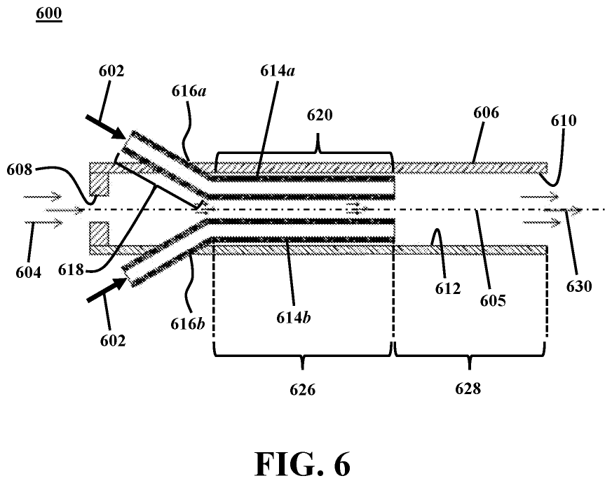

FIG. 6 illustrates a sectional side view of a device 600 for mixing a first fluid 602 into a second fluid 604, consistent with one or more exemplary embodiments of the present disclosure. In an exemplary embodiment, device 600 may include a main conduit 606 that may be extended along a longitudinal axis 605 of main conduit 606 between an inlet port 608 and an outlet port 610. In an exemplary embodiment, inlet port 608 may be connected in fluid communication with a pressurized source of second fluid 604, and second fluid 604 may flow through main conduit 606 from inlet port 608 towards outlet port 610. As used herein, considering the direction of flow within main conduit 606 from inlet port 608 to outlet port 610, outlet port 610 is considered to be downstream from inlet port 608.

In an exemplary embodiment, device 60 may further include a plurality of secondary conduits, such as secondary conduits (614a and 614b) that may be at least partially disposed within main conduit 606. In an exemplary embodiment, main conduit 606 may further include a plurality of apertures, such as apertures (616a and 616b) on a side wall 612 of main conduit 606 to allow for insertion of the plurality secondary conduits, such as secondary conduits (614a and 614b). In an exemplary embodiment, each secondary conduit may have an inclined portion and a straight portion, where the straight portion extend along longitudinal axis 605. For example, secondary conduit 614a may include an inclined portion 618 that may pass through aperture 612a and a straight portion 620 integrally formed with inclined portion 618. Straight portion 620 may run along longitudinal axis 605 into main conduit 606. In an exemplary embodiment, inclined portion 618 may be at an angle of between 0^{P} and 180° with respect to longitudinal axis 605.

In an exemplary embodiment, each secondary conduit may include an inlet and an outlet, where the outlet may be disposed within main conduit. For example, secondary conduit 614b may include an inlet 622 and an outlet 624. In an exemplary embodiment, inlet 622 may be connected in fluid communication with a source of first fluid 602.

In an exemplary embodiment, main conduit 606 may have a constant cross-sectional area extended along an entire length of main conduit 606. However, a portion of cross-sectional area of main conduit 606 may be occupied by the plurality of secondary conduits, such as secondary conduits (614a and 614b). Consequently, main conduit may be divided into two portions, namely a first portion 626 with a first cross-sectional area of flow and a second portion 628 with a second cross-sectional area of flow. In an exemplary embodiment, the second cross-sectional area of flow may be larger than the first cross-sectional area of flow and therefore, second fluid 602 may pass through first portion 626 with the smaller cross-sectional area, first, and then, suddenly enters second portion 628 with the larger cross-sectional area. A sudden reduction in the pressure of the stream of second fluid may lead to formation of low-pressure zones immediately downstream from the outlets of secondary conduits. Such low-pressure zones may create a suction within the plurality of secondary conduits and may draw in the first fluid. In an exemplary embodiment, first fluid may be discharged into second portion of main conduit under the negative pressure created at the outlet of each secondary conduit of the plurality of secondary conduits. In an exemplary embodiment, first fluid and second fluid may be mixed together and a mixed stream 630 may be discharged from device 600.

In an exemplary embodiment, first fluid stream 604 may coaxially enter main conduit 606 along longitudinal axis 605 of main conduit 606, while second fluid stream 602 may enter secondary conduits (614a and 614b) at an inclined angle with respect to longitudinal axis 605 of main conduit 606.

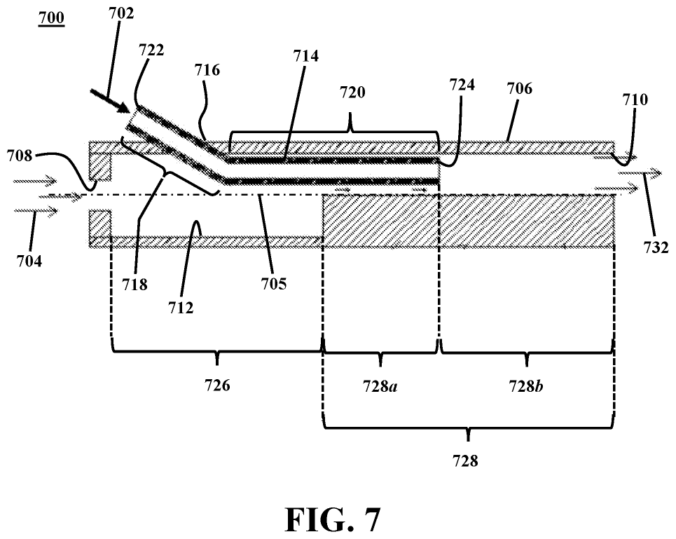

FIG. 7 illustrates a sectional side view of a device 700 for mixing a first fluid 702 into a second fluid 704, consistent with one or more exemplary embodiments of the present disclosure. In an exemplary embodiment, device 700 may include a main conduit 706 that may be extended along a longitudinal axis 705 of main conduit 706 between an inlet port 708 and an outlet port 710. In an exemplary embodiment, inlet port 708 may be connected in fluid communication with a pressurized source of second fluid 704, and second fluid 704 may flow through main conduit 706 from inlet port 708 towards outlet port 710. As used herein, considering the direction of flow within main conduit 706 from inlet port 708 to outlet port 710, outlet port 710 is considered to be downstream from inlet port 708.

In an exemplary embodiment, device 700 may further include a secondary conduit 714 that may be at least partially disposed within main conduit 706. In an exemplary embodiment, main conduit 706 may further include an aperture 716 on a side wall 712 of main conduit 706 to allow for insertion of secondary conduit 714. In an exemplary embodiment, secondary conduit 714 may include an inclined portion 718 that may pass through aperture 712 and a straight portion 720 integrally formed with inclined portion 718. Straight portion 720 may run along longitudinal axis 705 within main conduit 706.

In an exemplary embodiment, secondary conduit 714 may include an inlet 722 and an outlet 724. In an exemplary embodiment, inlet 722 may be connected in fluid communication with a source of first fluid 702.

In an exemplary embodiment, main conduit 706 may have two portions with different cross-sectional areas, namely a first portion 726 with a first cross-sectional area and a second portion 728 with a second cross-sectional area. In an exemplary embodiment, the first cross-sectional area of first portion 726 may be larger than the second cross-sectional area of second portion 728. In an exemplary embodiment, a portion of cross-sectional area of second portion 728 may be occupied by secondary conduits 714. Consequently, second portion 728 may further be divided into two sub-portions, namely a first sub-portion 728a with a first cross-sectional area of flow and a second sub-portion 728b with a second cross-sectional area of flow. In an exemplary embodiment, the second cross-sectional area of flow of second sub-portion 728b may be larger than the first cross-sectional area of flow of first sub-portion 728a and therefore, second fluid 702 may pass through first sub-portion 728a with the smaller cross-sectional area, first, and then, suddenly enters second sub-portion 728b with the larger cross-sectional area. A sudden reduction in the pressure of the stream of second fluid may lead to formation of a low-pressure zone immediately downstream from outlet 724 of secondary conduit 714. Such a low-pressure zone may create a suction within secondary conduit 714 and may draw in the first fluid. In an exemplary embodiment, first fluid may be discharged into second sub-portion 728a of main conduit 706 under the negative pressure created at outlet 724 of secondary conduit 714. In an exemplary embodiment, first fluid and second fluid may be mixed together and a mixed stream 630 may be discharged from device 600.

In an exemplary embodiment, the first cross-sectional area of first portion 726 may be constant for the entire length of first portion 726 and the second cross-sectional area of second portion 728 may also be constant for the entire length of second portion 728. In an exemplary embodiment, the first cross-sectional area of flow within first sub-portion 728a may be constant for the entire length of first sub-portion 728a and the second cross-sectional area of flow within second sub-portion 728b may be constant for the entire length of second sub-portion 728b.

In an exemplary embodiment, first fluid stream 704 may coaxially enter main conduit 706 along longitudinal axis 705 of main conduit 706, while second fluid stream 702 may enter secondary conduit 714 at an inclined angle with respect to longitudinal axis 705 of main conduit 706.

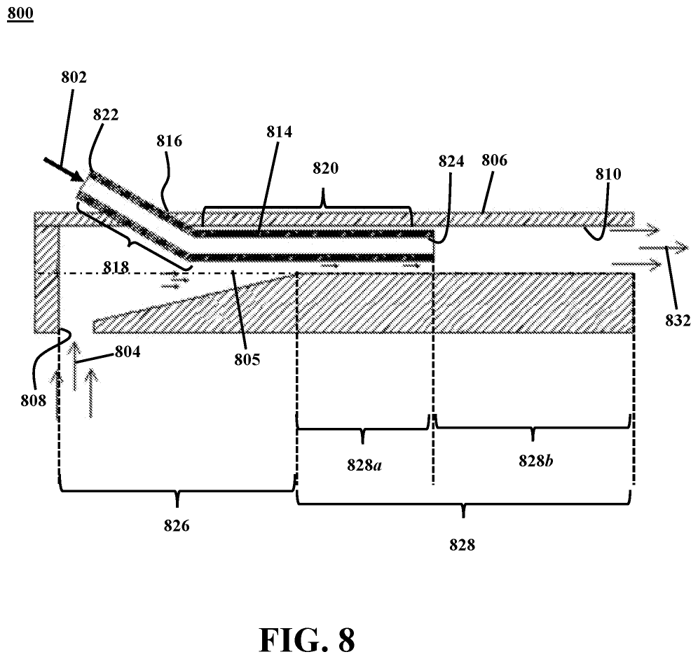

FIG. 8 illustrates a sectional side view of a device 800 for mixing a first fluid 802 into a second fluid 804, consistent with one or more exemplary embodiments of the present disclosure. In an exemplary embodiment, device 800 may include a main conduit 806 that may be extended along a longitudinal axis 805 of main conduit 806 between an inlet port 808 and an outlet port 810. In an exemplary embodiment, inlet port 808 may be connected in fluid communication with a pressurized source of second fluid 804, and second fluid 804 may flow through main conduit 806 from inlet port 808 towards outlet port 810. As used herein, considering the direction of flow within main conduit 806 from inlet port 808 to outlet port 810, outlet port 810 is considered to be downstream from inlet port 808.

In an exemplary embodiment, device 800 may further include a secondary conduit 814 that may be at least partially disposed within main conduit 806. In an exemplary embodiment, main conduit 806 may further include an aperture 816 on a side wall 812 of main conduit 806 to allow for insertion of secondary conduit 814. In an exemplary embodiment, secondary conduit 814 may include an inclined portion 818 that may pass through aperture 812 and a straight portion 820 integrally formed with inclined portion 818. Straight portion 820 may run along longitudinal axis 805 within main conduit 806.

In an exemplary embodiment, secondary conduit 814 may include an inlet 822 and an outlet 824. In an exemplary embodiment, inlet 822 may be connected in fluid communication with a source of first fluid 802.

In an exemplary embodiment, main conduit 806 may have two portions with different cross-sectional areas, namely a first portion 826 with a first cross-sectional area and a second portion 828 with a second cross-sectional area. In an exemplary embodiment, the first cross-sectional area of first portion 826 may be larger than the second cross-sectional area of second portion 828. In an exemplary embodiment, a portion of cross-sectional area of second portion 828 may be occupied by secondary conduits 814. Consequently, second portion 828 may further be divided into two sub-portions, namely a first sub-portion 828a with a first cross-sectional area of flow and a second sub-portion 828b with a second cross-sectional area of flow. In an exemplary embodiment, the second cross-sectional area of flow of second sub-portion 828b may be larger than the first cross-sectional area of flow of first sub-portion 828a and therefore, second fluid 802 may pass through first sub-portion 828a with the smaller cross-sectional area, first, and then, suddenly enters second sub-portion 828b with the larger cross-sectional area. A sudden reduction in the pressure of the stream of second fluid may lead to formation of a low-pressure zone immediately downstream from outlet 824 of secondary conduit 814. Such a low-pressure zone may create a suction within secondary conduit 814 and may draw in the first fluid. In an exemplary embodiment, first fluid may be discharged into second sub-portion 828a of main conduit 806 under the negative pressure created at outlet 824 of secondary conduit 814. In an exemplary embodiment, first fluid and second fluid may be mixed together and a mixed stream 832 may be discharged from device 800.

In an exemplary embodiment, the first cross-sectional area of first portion 826 may linearly decrease along the length of first portion 826 and the second cross-sectional area of second portion 828 may also be constant for the entire length of second portion 828. In an exemplary embodiment, the first cross-sectional area of flow within first sub-portion 828a may be constant for the entire length of first sub-portion 828a and the second cross-sectional area of flow within second sub-portion 828b may be constant for the entire length of second sub-portion 828b.

In an exemplary embodiment, first fluid stream 804 may enter main conduit 806 perpendicular to longitudinal axis 805 of main conduit 806, while second fluid stream 802 may enter secondary conduit 814 at an inclined angle with respect to longitudinal axis 805 of main conduit 806.

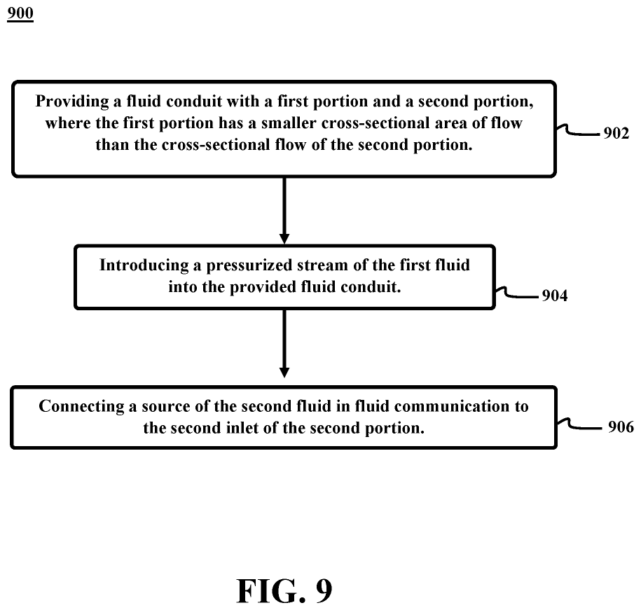

FIG. 9 illustrates a flow chart of a method 900 for mixing a first fluid with a second fluid, consistent with one or more exemplary embodiments of the present disclosure. In an exemplary embodiment, method 900 may be implemented by any of devices (30, 40, 50, 60, 70, and 80).

In an exemplary embodiment, method 900 may include a step 902 of providing a fluid conduit with two connected portions, namely, a first portion and a second portion, where the first portion may have a smaller cross-sectional area compared to the second portion. In an exemplary embodiment, method 900 may further include a step 904 of creating a low-pressure zone with the provided fluid conduit by introducing a pressurized stream of the first fluid into the provided fluid conduit. In an exemplary embodiment, method 900 may further include a step 906 of drawing a stream of the second fluid into the stream of the first fluid by connecting a source of the second fluid in fluid communication with the low-pressure zone within the provided conduit.

In an exemplary embodiment, step 902 of providing a fluid conduit with a first portion and a second portion, where the first portion has a smaller cross-sectional area of flow than the cross-sectional flow of the second portion. In an exemplary embodiment, step 902 of providing the fluid conduit may further include providing a fluid conduit with a discharge port that may open into the second portion of the provided fluid conduit immediately downstream of the formed shoulder of the provided fluid conduit. The discharge port may either radially open into the second portion from an outer wall of the second portion, for example, as illustrated in FIGS. 3A and 3B or the discharge port may axially open into the second portion from the shoulder of the provided fluid conduit, for example, as illustrated in FIGS. 4A and 4B.

In an exemplary embodiment, step 902 of providing the fluid conduit may further include providing a second conduit disposed within a first conduit. The first conduit may have a larger cross-sectional area in comparison with the second conduit. The second conduit may be at least partially disposed within the first conduit and thereby dividing the first conduit into a first portion with a smaller cross-sectional area of flow due to the presence of the second conduit, and a second portion with a larger cross-sectional area of flow compared to the first portion. The first conduit may either be inserted into the first conduit parallel with the first conduit or the second conduit may enter the first conduit through an outer wall of the second conduit at a certain angle and after entering an inner volume of the first conduit, the second conduit may run straight along the first conduit. In other words, the second conduit may include an inclined portion that passes through an outer wall of the first conduit into an inner volume of the first conduit and a second straight portion that may run parallel with the first conduit within the first conduit, for example as illustrated in FIGS. 6, 7, and 8. Such configurations of an exemplary fluid conduit may allow for providing a conduit with a sudden increase in the cross-sectional area of flow within that conduit in step 902.

In an exemplary embodiment, step 904 of introducing a pressurized stream of the first fluid into the provided fluid conduit. In an exemplary embodiment, responsive to a pressurized stream of first fluid introduced into the first portion or the second conduit of the provided fluid conduit may create a low-pressure zone adjacent and downstream from the point where the sudden increase in the cross-sectional area of flow occurs.

In an exemplary embodiment, step 906 of connecting a source of the second fluid in fluid communication with the low-pressure zone within the provided conduit. The source of second fluid may be connected in fluid communication with the created low-pressure zone utilizing apertures, such as inlet ports (310, 310a, 310b, 415) or by disposing an outlet port of the second conduit within the created low-pressure zone, such as second conduits (54, 614a, 614b, 714, and 814). Such exposure of an exemplary second fluid with an exemplary low-pressure zone within an exemplary conduit may allow for drawing an exemplary second fluid into an exemplary fluid conduit and thereby mixing an exemplary second fluid into an exemplary stream of first fluid. Such exemplary method for mixing a first fluid with a second fluid may be used for water aeration and may be utilized for water consumption reduction devices.

In an exemplary embodiment, step 902 of providing a fluid conduit may involve providing a fluid conduit including a first portion with a first cross-sectional area of flow, where the first portion may extend between a first inlet and a first outlet along a longitudinal axis of the first portion, a second portion with a second cross-sectional area of flow, where the second portion may extend between a second inlet and a second outlet along a longitudinal axis of the second port. In an exemplary embodiment, the second cross-sectional area of flow may be larger than the first cross-sectional area of flow and the first outlet of the first portion may be connected to the second inlet of the second portion. In an exemplary embodiment, the fluid conduit may further include a shoulder that may be formed between the first outlet of the first portion and the second inlet of the second portion, where the plane of the shoulder may be perpendicular to the longitudinal axis of the second portion.

In an exemplary embodiment, step 902 of providing the fluid conduit may further include providing the first portion with a constant first diameter for an entire length of the first portion, and providing the second portion with a constant second diameter for an entire length of the second portion.

In an exemplary embodiment, step 906 of connecting the source of the second fluid to the second inlet of the second portion may include connecting a secondary conduit to the second inlet of the second portion, the secondary conduit perpendicular to the longitudinal axis of the second portion.

In an exemplary embodiment, the shoulder may include an aperture in fluid communication with the second inlet of the second portion. In an exemplary embodiment, step 906 of connecting the source of the second fluid to the second inlet of the second portion may include connecting a secondary conduit to the second inlet of the second portion through the aperture, the secondary conduit parallel with the longitudinal axis of the second portion.

In an exemplary embodiment, step 902 of providing the fluid conduit may further include providing a primary annular conduit with a constant primary cross-sectional area for an entire length of the primary annular conduit, and dividing the primary annular conduit into the first portion and the second portion by disposing a secondary annular conduit within the first portion of the primary annular conduit. In an exemplary embodiment, the secondary conduit may have a constant secondary cross-sectional area of flow for an entire length of the secondary conduit, and the primary cross-sectional area may have a larger than the secondary cross-sectional area.

In an exemplary embodiment, step 906 of connecting the source of the second fluid to the second inlet of the second portion may include connecting the source of the second fluid to the secondary conduit. In an exemplary embodiment, the secondary conduit may extend between an inlet port and an outlet port. The outlet port may be disposed within the primary annular conduit at the second inlet of the second portion. In an exemplary embodiment, step 906 of connecting the source of the second fluid to the second inlet of the second portion may include connecting the inlet port of the secondary conduit to the source of the second fluid.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

Unless otherwise stated, all measurements, values, ratings, positions, magnitudes, sizes, and other specifications that are outlined in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to ascertain the nature of the technical disclosure quickly. It is submitted with the understanding that it will not be used to interpret or limit the scope or meaning of the claims. In addition, in the foregoing Detailed Description, it can be seen that various features are grouped in various implementations. This is for purposes of streamlining the disclosure and is not to be interpreted as reflecting an intention that the claimed implementations require more features than are expressly recited in each claim. Rather, as the following claims reflect, the inventive subject matter lies in less than all features of a single disclosed implementation. Thus, the following claims are hereby incorporated into the Detailed Description, with each claim standing on its own as a separately claimed subject matter.

While various implementations have been described, the description is intended to be exemplary, rather than limiting, and it will be apparent to those of ordinary skill in the art that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in the light of the attached claims and their equivalents. Also, various modifications and changes may be made within the scope of the attached claims.

What is claimed is:

1. A device for mixing a first fluid and a second fluid, the device comprising:
a primary conduit extended along a longitudinal axis of the primary conduit between a primary inlet port and a primary outlet port, the primary conduit with a constant primary inner diameter for an entire length of the primary conduit, the primary inlet port connected to a pressurized source of the first fluid;
at least one secondary conduit extended parallel with the primary conduit, the secondary conduit comprising a secondary inlet port and a secondary outlet port, the secondary conduit with a constant secondary inner diameter, the secondary inner diameter smaller than the primary inner diameter,
wherein, the primary conduit encompasses at least a portion of the secondary conduit, the secondary outlet portion disposed within the primary conduit, the secondary inlet port connected in fluid communication with a source of the second fluid.

2. The device of claim 1, wherein the primary conduit comprises an annular primary wall extended between a first primary base end and a second primary base end, the primary inlet port located on the first primary base end of the annular primary conduit and the primary outlet port located on the second primary base end of the annular primary conduit.

3. The device of claim 2, wherein the secondary conduit comprises an annular secondary wall extended between a first secondary base end and a second secondary base end, the secondary inlet port located on the first secondary base end of the annular secondary conduit and the secondary outlet port located on a second opposing secondary base end of the annular secondary conduit.

4. The device of claim 3, wherein at least a portion of an outer surface of the annular secondary wall is exposed to an inner volume of the primary conduit.

5. The device of claim 4, wherein the primary inlet port is configured to allow for the at least one secondary conduit to enter the primary conduit, a longitudinal axis of the secondary conduit perpendicular to a plane of the primary inlet port.

6. The device of claim 5, wherein a ratio of the secondary inner diameter to the primary inner diameter is between 0.1 and 1.

7. The device of claim 4, wherein the secondary conduit comprises a first portion connected to a second portion, the first portion longitudinally extended along an axis inclined at an angle relative to the longitudinal axis of the primary conduit, the second portion longitudinally extended parallel with the longitudinal axis of the primary conduit.

8. The device of claim 7, wherein the angle comprises an angle between 0° and 180°.

9. The device of claim 1, wherein the primary conduit comprises an annular primary wall extended between a first primary base end and a second primary base end, the primary inlet port located on the annular primary wall of the annular primary conduit, the primary outlet port located on the second primary base end of the annular primary conduit, a plane of the primary inlet port parallel with the longitudinal axis of the primary conduit.

10. The device of claim 9, wherein the secondary conduit comprises an annular secondary wall extended between a first secondary base end and a second secondary base end, the secondary inlet port located on the first secondary base end of the annular secondary conduit and the secondary outlet port located on a second opposing secondary base end of the annular secondary conduit, a plane of the secondary inlet port perpendicular to the plane of the primary inlet port.

11. A method for mixing a first fluid and a second fluid, the method comprising:
providing a fluid conduit, the fluid conduit comprising:
a first portion with a first cross-sectional area of flow, the first portion extended between a first inlet and a first outlet along a longitudinal axis of the first portion;
a second portion with a second cross-sectional area of flow, the second portion extended between a second inlet and a second outlet along a longitudinal axis of the second port, the second cross-sectional area of flow larger than the first cross-sectional area of flow, the first outlet of the first portion connected to the second inlet of the second portion; and
a shoulder formed between the first outlet of the first portion and the second inlet of the second portion, the plane of the shoulder perpendicular to the longitudinal axis of the second portion; introducing a pressurized stream of the first fluid into the provided fluid conduit, the pressurized stream of first fluid flowing from the first inlet port of the first portion to the second outlet of the second portion; and
connecting a source of the second fluid in fluid communication to the second inlet of the second portion.

12. The method of claim 11, wherein providing the fluid conduit further comprises:
providing the first portion with a constant first diameter for an entire length of the first portion; and
providing the second portion with a constant second diameter for an entire length of the second portion.

13. The method of claim 12, wherein connecting the source of the second fluid to the second inlet of the second portion comprises connecting a secondary conduit to the second inlet of the second portion, the secondary conduit perpendicular to the longitudinal axis of the second portion.

14. The method of claim 12, wherein the shoulder comprises an aperture in fluid communication with the second inlet of the second portion, wherein connecting the source of the second fluid to the second inlet of the second portion comprises connecting a secondary conduit to the second inlet of the second portion through the aperture, the secondary conduit parallel with the longitudinal axis of the second portion.

15. The method of claim 12, wherein providing the conduit comprises:
providing a primary annular conduit with a constant primary cross-sectional area for an entire length of the primary annular conduit; and
dividing the primary annular conduit into the first portion and the second portion by disposing a secondary annular conduit within the first portion of the primary annular conduit, the secondary conduit with a constant secondary cross-sectional area of flow for an entire length of the secondary conduit, the primary cross-sectional area larger than the secondary cross-sectional area.

16. The method of claim 15, wherein connecting the source of the second fluid to the second inlet of the second portion comprises connecting the source of the second fluid to the secondary conduit.

17. The method of claim 16, wherein the secondary conduit extends between an inlet port and an outlet port, the outlet port disposed within the primary annular conduit at the second inlet of the second portion, wherein connecting the source of the second fluid to the second inlet of the second portion comprises connecting the inlet port of the secondary conduit to the source of the second fluid.
